(19) United States
(12) Patent Application Publication
(10) Pub. No.: US 2010/0089978 A1
(43) Pub. Date: Apr. 15, 2010

(54) METHOD AND APPARATUS FOR WAFER BONDING

(75) Inventors: EMMETT HUGHLETT, WATERBURY, VT (US); THOMAS PRICE, Jerico, VT (US); HALE JOHNSON, JERICHO, VT (US)

Correspondence Address: AKC PATENTS, 215 GROVE ST., NEWTON, MA, 02466, US

(73) Assignee: SUSS MICROTEC INC, Waterbury Center, VT (US)

(21) Appl. No.: 12/481,692

(22) Filed: Jun. 10, 2009

Related U.S. Application Data
(60) Provisional application No. 61/060,531, filed on Jun. 11, 2008.

(51) Int. Cl. B23K 20/24

(52) U.S. Cl. 228/116; 228/3.1

(57) ABSTRACT

An improved apparatus for bonding semiconductor structures includes equipment for treating a first surface of a first semiconductor structure and a first surface of a second semiconductor structure with formic acid, equipment for positioning the first surface of the first semiconductor structure directly opposite and in contact with the first surface of the second semiconductor structure and equipment for forming a bond interface between the treated first surfaces of the first and second semiconductor structures by pressing the first and second semiconductor structures together. The equipment for treating the surfaces of the first and second semiconductor structures with formic acid includes a sealed tank filled partially with liquid formic acid and partially with formic acid vapor. Opening an inlet valve connects the tank to a nitrogen gas source and allows nitrogen gas to flow through the tank. Opening an outlet valve allows a mixture of formic acid vapor with nitrogen gas to flow out of the tank. The mixture is used for treating the surfaces of the first and second semiconductor structures.

### CROSS REFERENCE TO RELATED CO-PENDING APPLICATIONS

This application claims the benefit of U.S. provisional application Ser. No. 61/060,531 filed Jun. 11, 2008 and entitled “IMPROVED METHOD AND APPARATUS FOR WAFER BONDING”, the contents of which are expressly incorporated herein by reference.

### FIELD OF THE INVENTION

The present invention relates to an improved method and apparatus for semiconductor wafer bonding, and more particularly to an improved industrial-scale semiconductor wafer bonding operation that combines wafer surface treatment followed by direct wafer bonding.

### BACKGROUND OF THE INVENTION

Wafer-to-wafer (W2W) bonding is deployed in a wide range of semiconductor process applications for forming semiconductor devices. Examples of semiconductor process applications where wafer-to-wafer bonding is applied include substrate engineering and fabrication of integrated circuits, packaging and encapsulation of micro-electro-mechanical-systems (MEMS) and stacking of many processed layers (3D-integration) of pure microelectronics. The quality of the wafer-to-wafer bond affects the overall processing yield and manufacturing cost of these devices and ultimately the cost of the electronic products that incorporate these devices.

There are a number of wafer-to-wafer bonding methods. Of interest here are those methods that depend on the wafer surface metal structures as the joining adhesive. Examples of these metal structures are copper, gold, or aluminum pads and lines. In many cases one or both wafers will have opposing metal structures where at least one wafer will carry metal solder to act as an adhesive at the joining points. In other cases, the metal structures themselves are welded to join the wafers. In all metal joining methods, the joining metals must be free of oxides and organic contamination to ensure a strong bond. Two methods for W2W bonding using metal joining are direct wafer bonding and thermocompression bonding.

Direct wafer bonding refers to a process where two separate wafer surfaces are brought into contact and are bonded without any intermediate adhesives or external force. The initial bond strength is usually weak, and therefore a subsequent annealing step is generally carried out to strengthen the bond. The direct wafer bonding process can be viewed as a three-step process, including surface activation, room temperature bonding and annealing. The room temperature bonding, also known as pre-bonding is based on inter-atomic and intermolecular forces, also known as Van-der-Waals forces, hydrogen or water bridges. These forces are relatively weak. However, in many cases, a spontaneous bonding of two clean and flat surfaces occurs when initiated only in one single point. Typically the bonding is initiated in the center or at the edge. Once the bonding is initiated a so-called bonding front propagates across the bonding interface, as shown in the IR images of FIG. 1. Referring to FIG. 1, in a first step two wafer surfaces 40 are brought into close proximity so that there is a small air gap between them and then they are pushed together in a single point 35 to reach an atomic scale distance between the wafer surfaces in that single point (30A). As was mentioned above, this point 35 is usually at the edge or the center of the wafers 40. Next, the bond front 36 propagates across the whole interface under its own momentum at a speed of 10 to 30 millimeters per second leaving behind a bonded area 34 without an interface gap (30B). Finally, the bond front 36 reaches the opposite edge of the wafer surface and the bonding is completed (30C). The bond front propagation speed and bonding time depend on many substrate parameters such as material, bow, flatness, micro-roughness and cleanliness. Device design and relative bond surface play also a major role in the bond front propagation. Finally pretreatment of the bond surfaces has a big impact on the overall bond quality.

Thermocompression bonding joins two wafers by using force and pressure to solder or weld the opposing metal structures of the wafer pair. FIG. 4A is a schematic diagram of the equipment used to heat and press (thermocompress) two wafers to form a bonded pair.

Several pretreatment methods of the bond surfaces have been suggested. However, most of the suggested methods are either not efficient or scalable to accommodate large scale semiconductor manufacturing processes. Accordingly, there is a need for an industrial-scale semiconductor wafer bonding operation that combines wafer surface treatment followed by direct wafer bonding.

### SUMMARY OF THE INVENTION

In general, in one aspect, the invention features an improved apparatus for bonding semiconductor structures comprising equipment for treating a first surface of a first semiconductor structure and a first surface of a second semiconductor structure with formic acid, equipment for positioning the first surface of the first semiconductor structure directly opposite and in contact with the first surface of the second semiconductor structure and equipment for forming a bond interface between the treated first surfaces of the first and second semiconductor structures by pressing the first and second semiconductor structures together.

Implementations of this aspect of the invention may include one or more of the following features. The equipment for treating the surfaces of the first and second semiconductor structures with formic acid includes a sealed tank filled partially with liquid formic acid and partially with formic acid vapor. The tank includes an inlet valve and an outlet valve. Opening the inlet valve connects the tank to a nitrogen gas source and allows nitrogen gas to flow through the tank. Opening the outlet valve allows a mixture of formic acid vapor with nitrogen gas to flow out of the tank and the mixture is then used for treating the surfaces of the first and second semiconductor structures. The mixture is adjusted to comprise 4% of formic acid. The equipment for treating the surfaces of the first and second semiconductor structures with formic acid further includes a leak detector for detecting low levels of formic acid vapor outside of the formic acid treatment equipment. The equipment for treating the surfaces of the first and second semiconductor structures with formic acid further includes a nitrogen gas pressure sensor, a pressure monitor device, a nitrogen gas pressure regulator, a nitrogen gas flow meter, a gas control valve configured to be materially compatible with formic acid, an error indicator for indicating nitrogen gas pressure below a set value, and an electrical lock-out switch configured to shut off electrical power to the equipment in cases where an error is indicated or a formic acid leak is detected. The tank further comprises a tank pressure gauge monitoring pressure inside the tank, and high and low formic acid level sensors indicating the fill level of the liquid formic acid in the tank. The equipment for treating the surfaces of the first and second semiconductor structures with formic acid is made of materials compatible with formic acid. The equipment for treating the surfaces of the first and second semiconductor structures with formic acid further comprises means for preventing tipping of the equipment, a first enclosure cabinet and a second enclosure cabinet. The first enclosure cabinet encloses the tank, the tank pressure gauge, the tank inlet and outlet valves, a tank bypass valve, a tank shut-off valve, and the high and low formic acid level sensors. The second enclosure cabinet encloses the nitrogen gas pressure sensor, the pressure monitor device, the nitrogen gas pressure regulator, the nitrogen gas flow meter, the gas control valve, the error indicator, the electrical lock-out switch, a status indicator, and a purge valve. The equipment for treating the surfaces of the first and second semiconductor structures with formic acid further comprises at least one tubing connecting the tank to the positioning and/or bonding equipment. All connections between the tubing and the tank are enclosed in the first enclosure cabinet.

In general, in another aspect, the invention features an improved method for bonding semiconductor structures comprising treating a first surface of a first semiconductor structure and a first surface of a second semiconductor structure with formic acid, positioning the first surface of the first semiconductor structure directly opposite and in contact with the first surface of the second semiconductor structure and forming a bond interface between the treated first surfaces of the first and second semiconductor structures by pressing the first and second semiconductor structures together. The formic acid is provided by a sealed tank filled partially with liquid formic acid and partially with formic acid vapor. The tank comprises an inlet valve and an outlet valve. Opening the inlet valve connects the tank to a nitrogen gas source and allows nitrogen gas to flow through the tank. Opening the outlet valve allows a mixture of formic acid vapor with nitrogen gas to flow out of the tank for treating the surfaces of the first and second semiconductor structures.

### BRIEF DESCRIPTION OF THE DRAWINGS

Referring to the figures, wherein like numerals represent like parts throughout the several views:

FIG. 1 depicts IR images of the various wafer bonding phases;

FIG. 2 is a schematic diagram of a two wafer bonding set-up at the stage before the bonding is initiated;

FIG. 3 is a schematic diagram of the two wafer bonding set-up of FIG. 2 at the stage where the top wafer floats on top of the lower wafer;

FIG. 4 is a schematic diagram of the two wafer bonding set-up of FIG. 2 at the stage where the bonding is initiated;

FIG. 4A is a side cross-sectional diagram of a thermocompression wafer bonding chamber 80;

FIG. 5 is a schematic overview diagram of the wafer bonding apparatus of this invention;

FIG. 6 is a schematic diagram of the formic acid bubbler of FIG. 5;

FIG. 7 depicts a schematic diagram of the bubbler electronics cabinet;

FIG. 8 depicts a schematic diagram of the bubbler gas cabinet;

FIG. 9 is a continuation of FIG. 8;

FIG. 10 depicts a schematic diagram of the process chamber;

FIG. 11 depicts images of wafer surfaces after being exposed to formic acid vapors (A, B) and prior to being exposed to any surface scrubbing;

FIG. 12 depicts an acoustic image of the wafer bond produced with the process of this invention; and

FIG. 13 depicts the formic acid tank and enclosure.

### DETAILED DESCRIPTION OF THE INVENTION

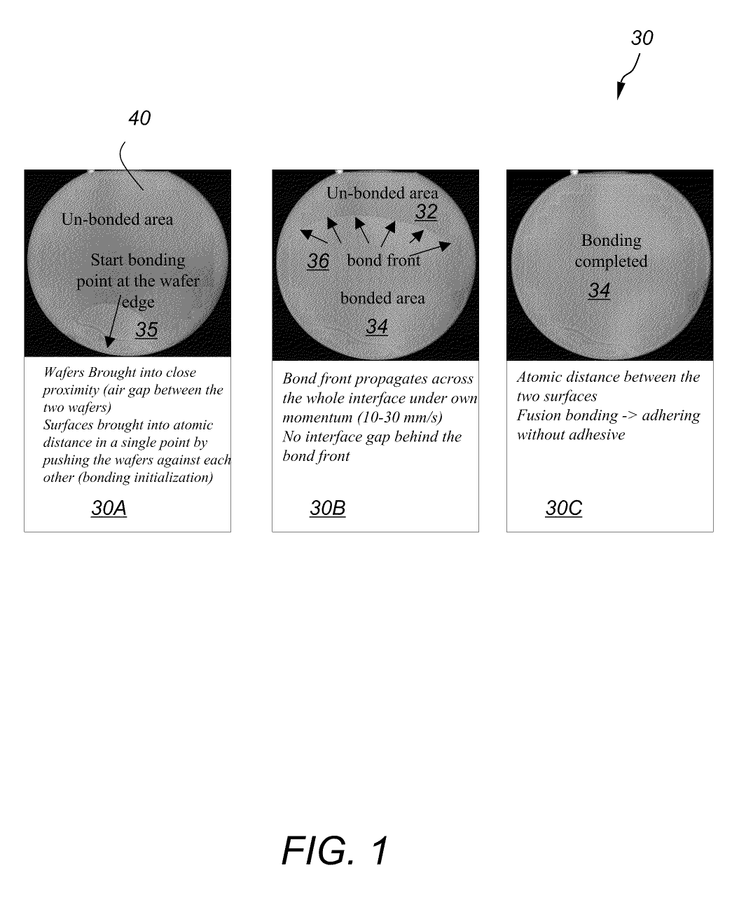

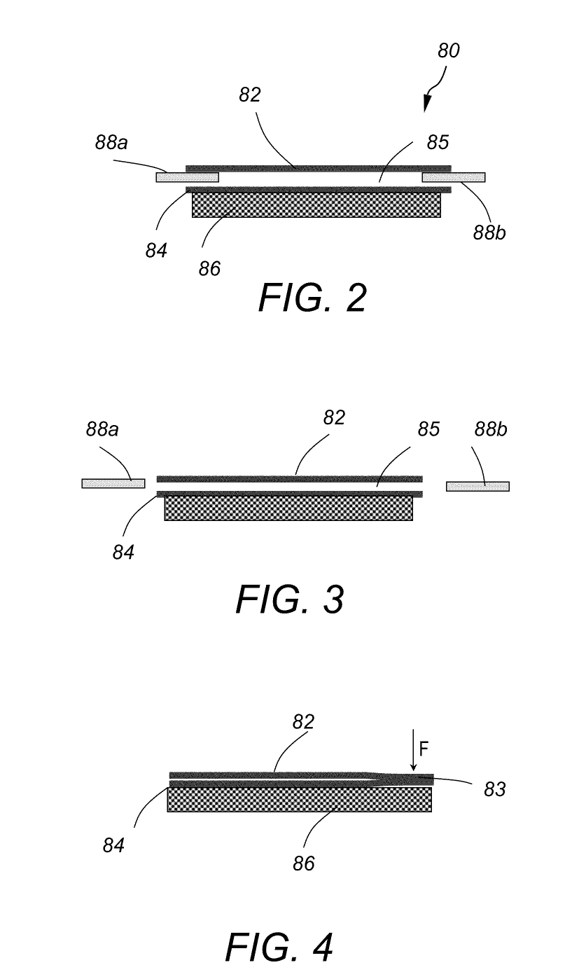

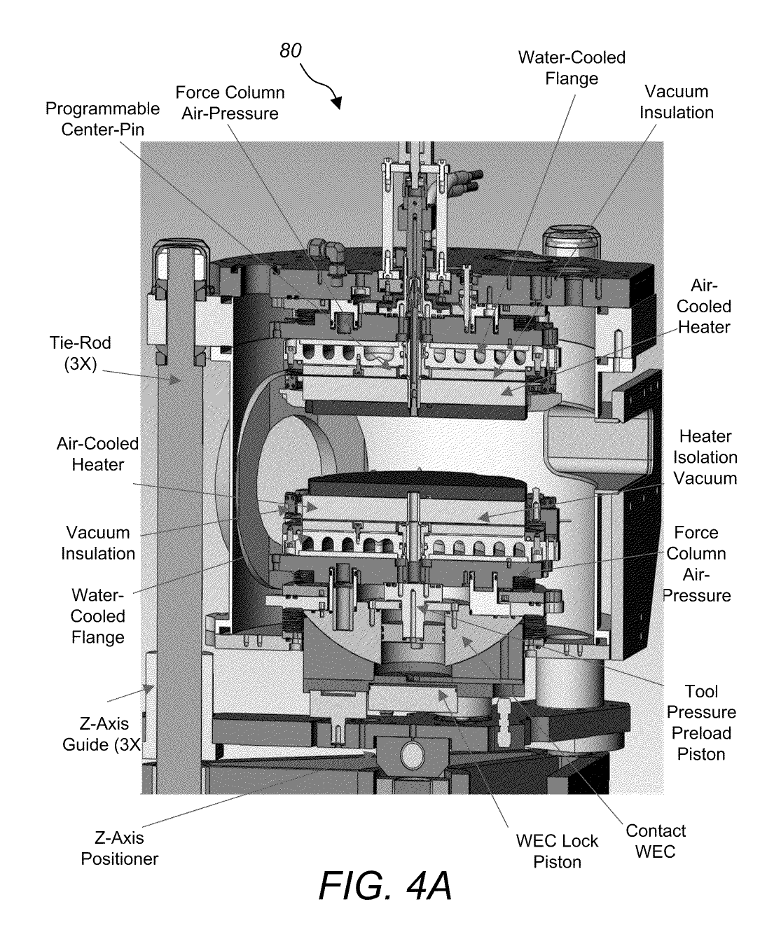

In a direct bonding process typically the wafers are oriented horizontally, as shown in FIG. 2. The lower wafer 84 is placed face up on flat carrier (chuck) 86 with a specific diameter. The upper wafer 82 is placed face down on mechanical spacers 88a, 88b. The proximity gap 85 between the wafers is defined by the spacer thickness and position. Next, the spacers 88a, 88b are removed and the upper wafer 82 floats on top of the lower wafer 85 because of the air cushion 85 between the two flat surfaces, as shown in FIG. 3. Next, a force F is applied at one single point 83 (typically at wafer edge or center) to bring the wafers 82, 84 in atomic contact and initiate the bonding based on Van-der-Waals forces, as shown in FIG. 4. A linear or circular bond front propagates, moving the air out of the interface 85 and leaving the surfaces in atomic contact, as shown in FIG. 1.

Direct bonding of silicon wafers requires smooth wafer surfaces both on the macroscopic and microscopic level. These requirements translate macroscopically into a surface bow of less than 40 micrometers and total indicated runout (TIR) of less than 2 micrometers and microscopically into surface roughness of root mean square (RMS) of less than 2 micrometers. These requirements are very difficult to attain in large scale manufacturing processes. As a result, extensive planarization steps via CMP and high forces during bonding are usually required to avoid surface defects, voids, and trapped gases at the bond interface.

Furthermore, metal-to-metal bonds, such as Cu—Cu or Al—Al bonding are affected by surface oxidation, as well as grain size control. Grain boundaries contribute to an increase in metal diffusion along the grain boundaries and result in increased bonding throughput. On the other hand, oxidation of the metal surfaces results in layers of surface oxides that need to be “cracked” to allow diffusion of metals to the bond interface. This is particularly true in the case of Al—Al bond where surface oxidation occurs even at room temperature and vacuum environment. As a result, a large force needs to be applied to “crack” the oxide layers. The applied force is usually 2-3 times higher than the force needed for bonding pure metals. The same oxide formation occurs on Cu-surfaces. However, copper oxide is soluble in copper and although it requires cleaning and passivation it does not require a very large force to be applied. Oxide removal prior to the bonding process reduces the required bond force and increases the bond yield to about 100%. Accordingly, oxide removal prior to bonding is advantageous in direct silicon-to-silicon and metal-to-metal bonds.

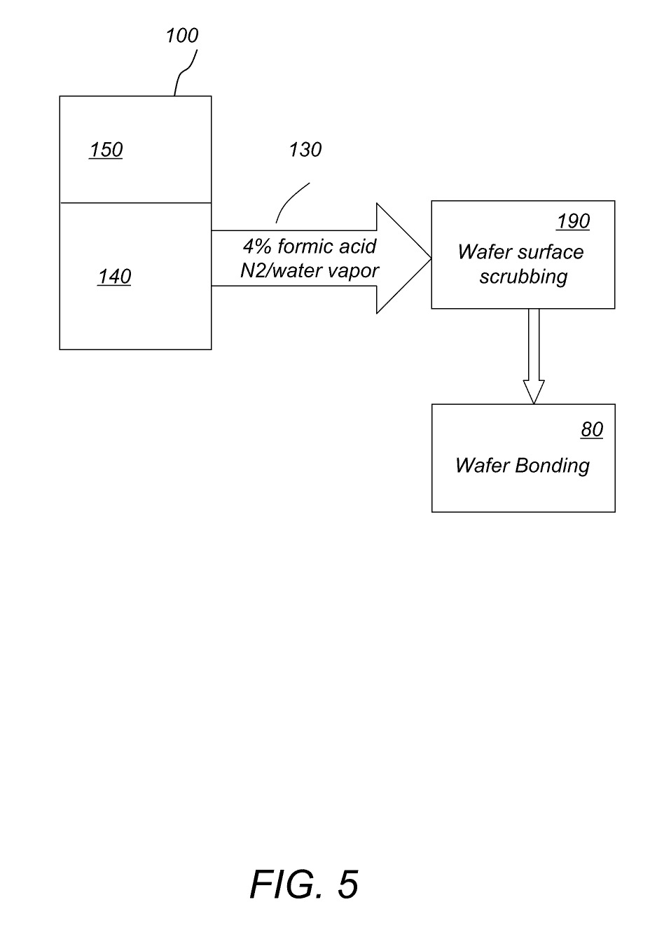

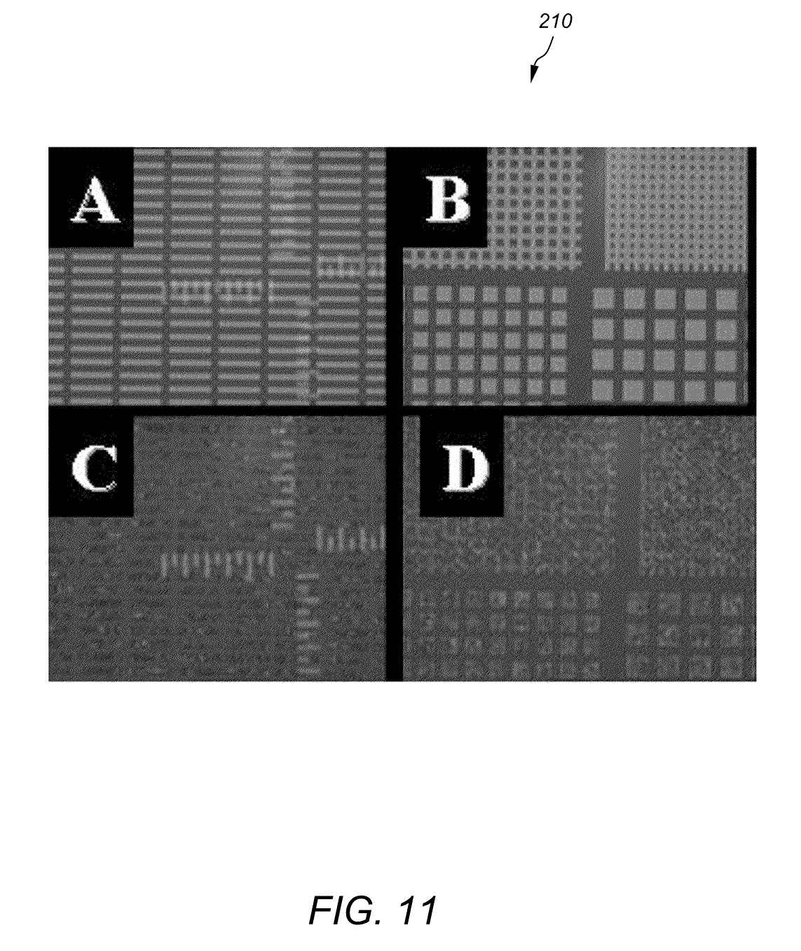

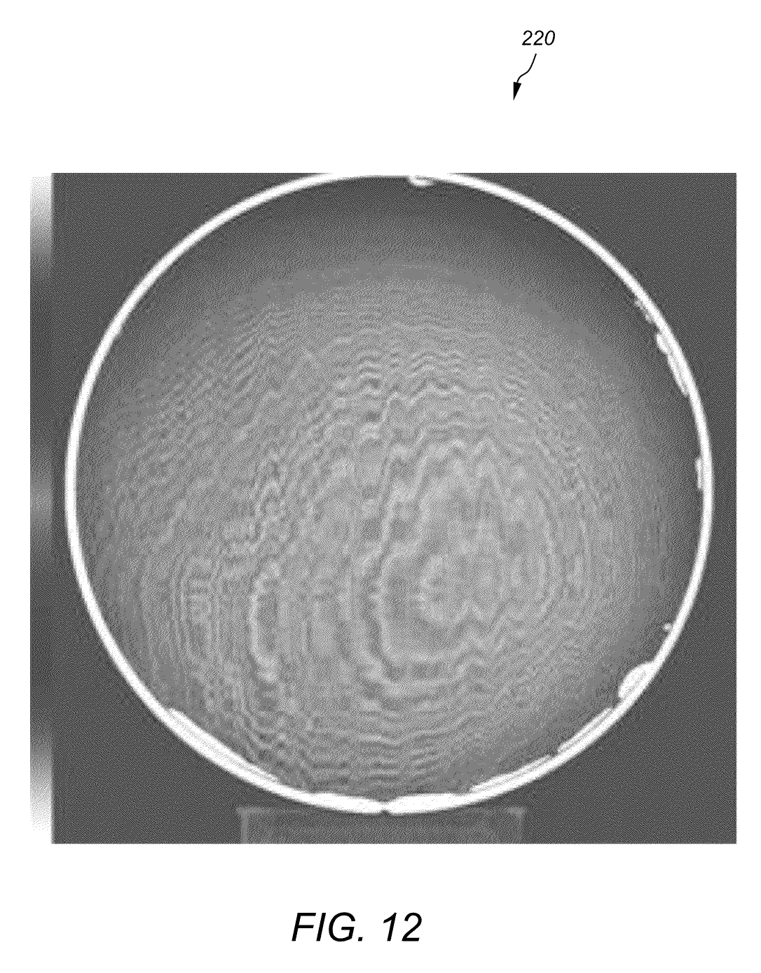

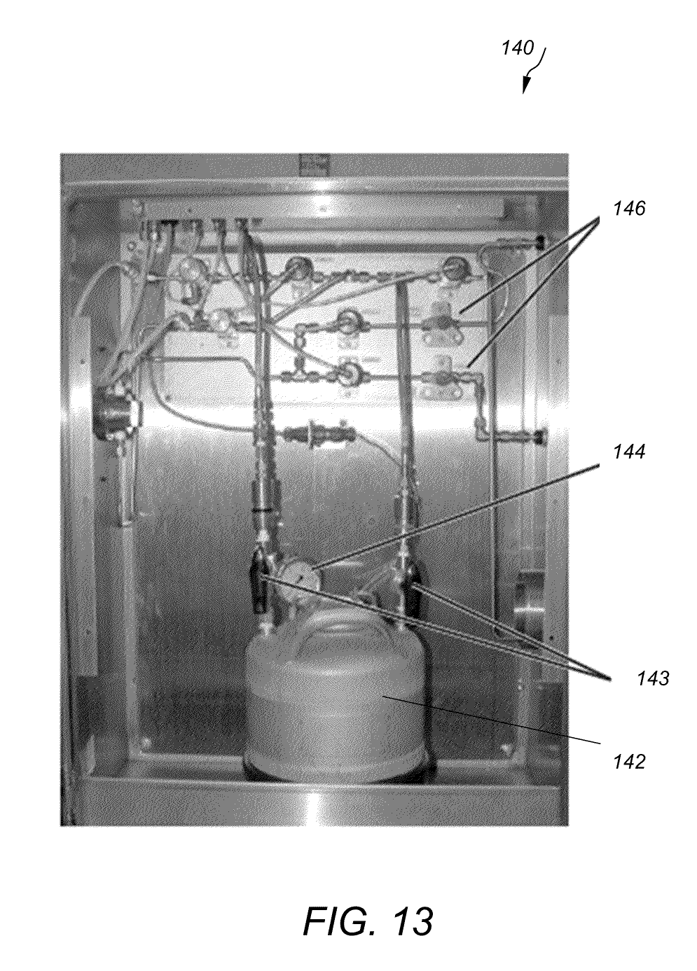

In one embodiment, formic acid is used to remove any surface oxides prior to the bonding process, as shown in FIG. 5. Formic acid 130 is mixed with nitrogen vapor and water vapor to a concentration up to 4% and is supplied to the process chamber 190 at a rate of 10 liters per minute. In the process chamber 190, the semiconductor wafer surfaces and metal surfaces are exposed to the formic acid vapors for a time interval between 1-10 minutes at temperatures in the range between 25° C. and 60° C. After this exposure to formic acid vapors the wafer surfaces are bonded in the bonding chamber 80 according to the process described above. We observe that wafer bonding immediately after the oxide removal with the formic acid occurs at lower process pressure (lower applied force) and lower process temperature and the bond quality and yield are increased. In one example, Al—Al bonding after surface exposure to formic acid occurs at a process temperature of 350° C. and applied force of less than 40 KN, whereas Al—Al bonding without prior surface exposure to formic acid occurs at an elevated force of 90 KN. Similarly, Cu—Cu bonding after exposure to formic acid occurs at a process temperature of 450° C. and applied force of less than 30 KN, whereas without prior exposure to formic acid Cu—Cu bonding occurs at an applied force of 80 KN. The reduction of applied force broadens the range of semiconductor device types that can be processed with thermocompression bonding because some device types are sensitive to extreme pressure. FIG. 11 depicts optical images of wafers treated with formic acid vapor (A, B) and images of untreated wafer surfaces (C, D). Severe surface oxidation is visible in the untreated surfaces (C, D). FIG. 12 depicts an acoustic image of 200 mm Cu—Cu bonding after surface pretreatment with formic acid vapor. Bonding was performed on SUSS SB8e bonder at 20 KN force and at 450° C. for 1 hr.

Formic acid (or methanoic acid) is a carboxylic acid that occurs naturally in the venom of bees and ant stings. At the industrial level, formic acid is produced as a byproduct in the manufacture of other chemicals such as acetic acid or is synthesized by reacting methanol with carbon monoxide at elevated temperature and pressure (80° C. and 40 atm). Safety is a major concern both with the production method and with formic acid itself. The principal danger from formic acid is due to exposure of skin or eye to liquid formic acid or contact with the concentrated vapors. Any of these exposure routes can cause severe chemical burns, and eye exposure can result in permanent eye damage. Inhaled vapors may similarly cause irritation or burns in the respiratory tract. Since carbon monoxide may also be present in formic acid vapors, care should be taken wherever large quantities of formic acid fumes are present. The US OSHA Permissible Exposure Level (PEL) of formic acid vapor in the work environment is 5 parts per million parts of air (ppm). Formic acid is readily metabolized and eliminated by the body. Nonetheless, some chronic effects have been documented, including allergies, liver or kidney damage. Accordingly, there is a need for a safe method of delivering formic acid in the oxide removal chamber.

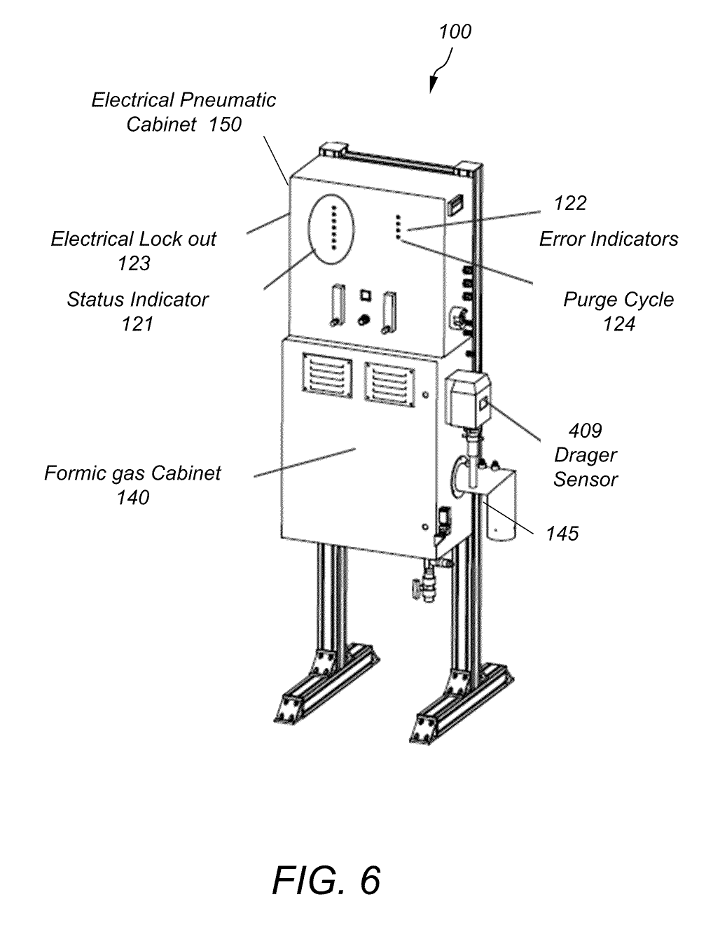

Referring to FIG. 5 a formic acid bubbler 100 provides 4% formic acid aerosol in a nitrogen atmosphere for use in the process chamber 190 prior to applying the bonding process 80. The bubbler flows room temperature nitrogen through a tank filled with liquid formic acid and produces the 4% formic acid aerosol in nitrogen atmosphere. The bubbler includes a gas cabinet 140, and an electrical/pneumatic cabinet 150, also shown in FIG. 6.

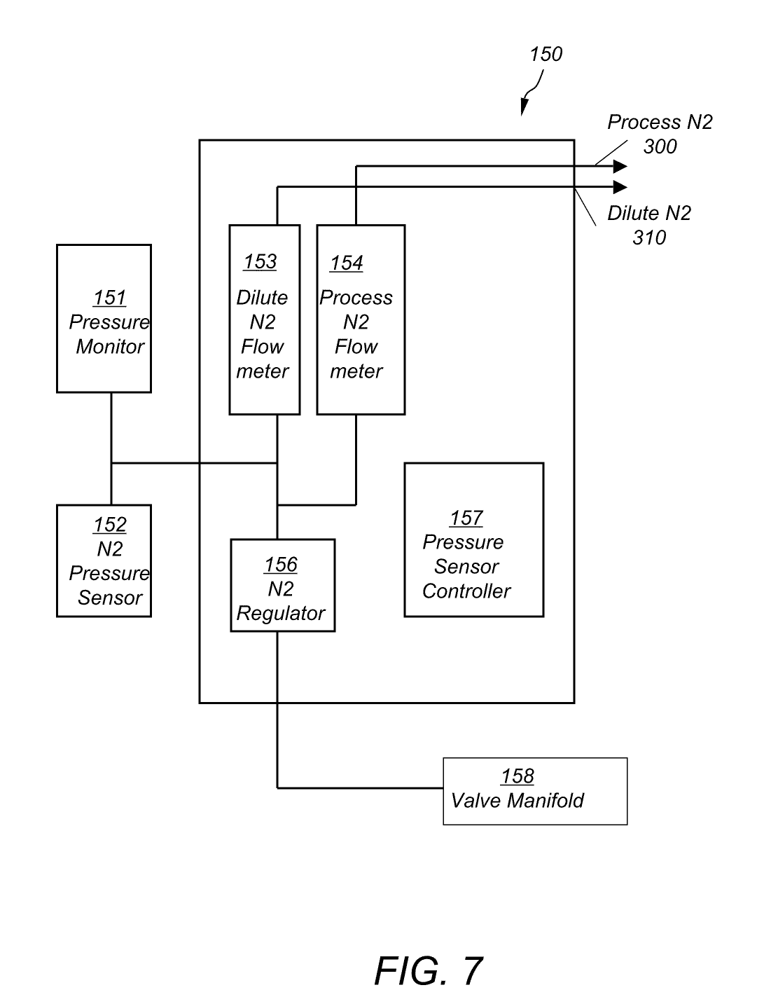

Referring to FIG. 7, the electrical/pneumatic cabinet 150 includes a nitrogen process gas pressure sensor 152, a pressure monitor 151, a valve manifold of gas controls 158, nitrogen process gas pressure regulator 156, flow meters for dilute nitrogen 153 and for the nitrogen process gas 154, a pressure sensor controller 157 and control electronics. Gas controls 158 are pneumatically driven stainless steel valves with formic acid compatible seals. Cabinet 150 also includes a status indicator 121, error indicators 122, an electrical lock out 123 and a purge valve 124. If the nitrogen supply pressure to the bubbler cabinet falls below a certain pressure (i.e., 30 psi) the system goes into an Emergency Off (EMO) state, a corresponding error indicator becomes lit and the power to the system is removed. Similarly, if there is a formic acid leak inside the bubbler (i.e., formic acid more than 10 ppm) the system goes into an EMO state, a corresponding error indicator goes on and the power is removed.

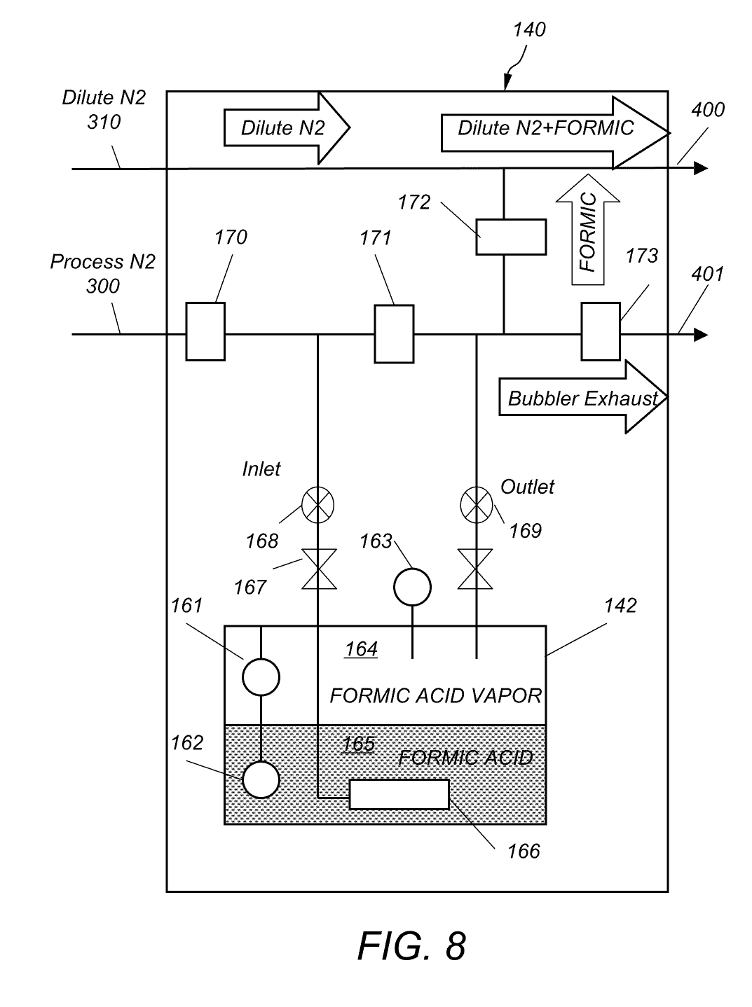

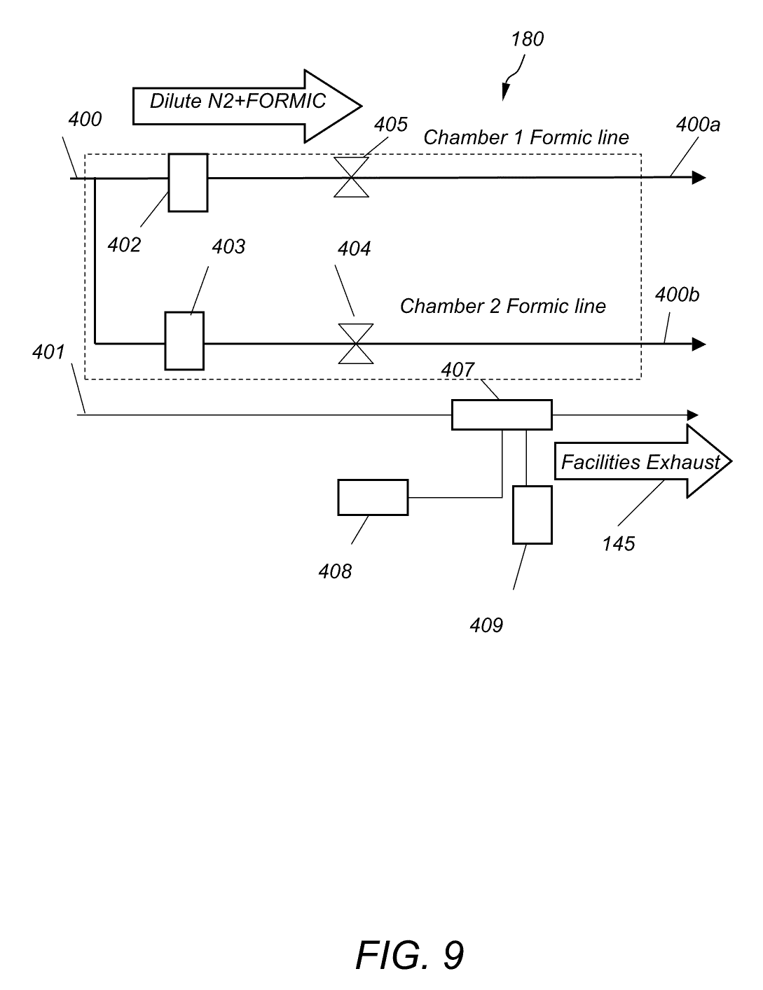

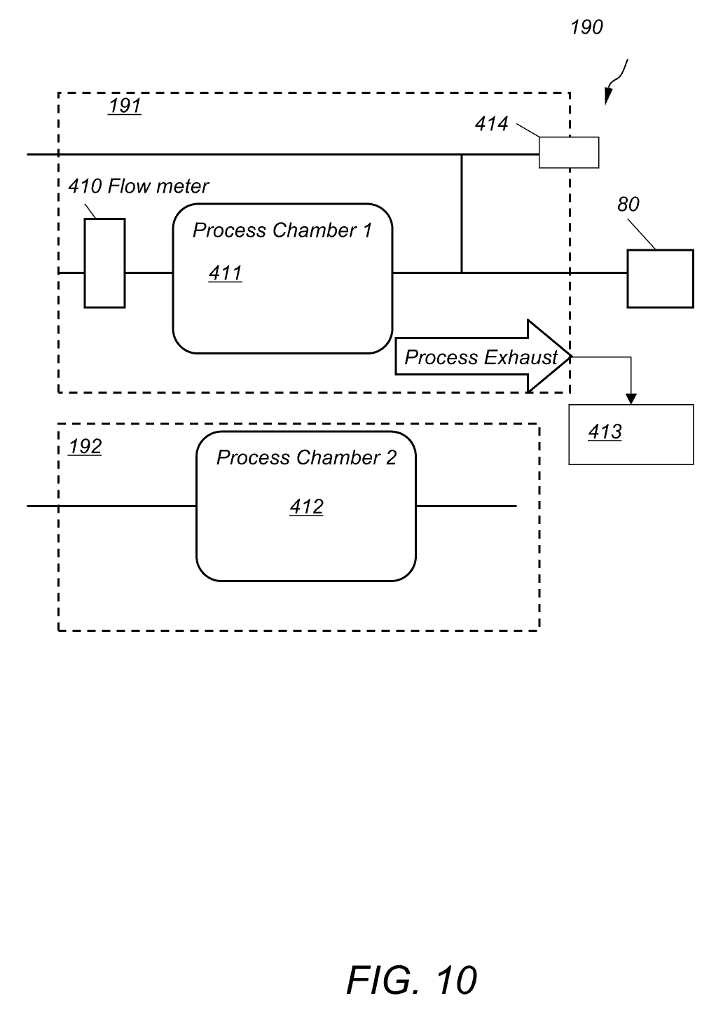

Referring to FIG. 8, gas cabinet 140 contains a replaceable formic acid tank 142, tank pressure gauge 163, manual shutoff valves 167, inlet and outlet quick couplings 168,168, respectively, tank inlet valve 170, tank bypass valve 171, tank outlet valve, and a drain port 401 containing a formic acid leak detector 409, shown in FIG. 9. In one example, leak detector 409 is an electro-chemical sensor capable of detecting low levels of acid vapors, manufactured by Draeger Safety Inc. The Draeger sensor includes a glass vial filled with a chemical reagent that reacts with formic acid and changes color. The length of the color change in the glass vial indicates the measured concentration of the formic acid. The formic acid tank 142 is easily changed using the manual shutoff valves 167 and quick disconnects 168, 169. Tank 142 also includes high 161 and low 162 formic acid level sensors indicating the fill level of the formic acid liquid in the tank. The gas cabinet is connected to the facilities solvent exhaust 145 for safety. The exhaust connection is via a 4″ OD fitting 145 on the right side of the gas cabinet and is made of a material rated for exposure to corrosive gasses such as stainless steel. The nitrogen process line 300 delivers nitrogen into the formic acid tank 142 where it is mixed with formic acid vapor 164 to form a formic acid/nitrogen aerosol. The formic acid/nitrogen aerosol exits the tank 142 and is further diluted with nitrogen from the dilute nitrogen line 310 to form the 4% formic acid/nitrogen aerosol in line 400 exiting the gas bubbler. Line 400 splits into two lines 400a, 400b that deliver the 4% formic acid/nitrogen aerosol to process chambers 411, 412, respectively, where the surface oxide removal from the wafer surfaces takes place. After the oxide removal step, the wafers are moved to the bonding chamber 80.

Given the hazardous nature of formic acid the bubbler includes the following safeguards. Acid vapor detector 409 on the exhaust line 145, loss of exhaust pressure detector, non formic compatible components in a separate cabinet, loss of nitrogen pressure switch, manual lockout for each chamber and liquid leak detector in formic gas cabinet. Furthermore, the bubbler is mechanically secured to prevent tipping. In one example, the legs of the bubbler are bolted to the floor to prevent tipping.

In other embodiments, the oxide removal occurs in the same chamber where the bonding takes place. In either case, the bubbler delivers the formic acid aerosol to the process and or bonding chamber via stainless steel tubing. There are no connections in the line between the process/bonding chamber and the bubbler. All connections are located in the exhaust area.

Several embodiments of the present invention have been described. Nevertheless, it will be understood that various modifications may be made without departing from the spirit and scope of the invention. Accordingly, other embodiments are within the scope of the following claims.

What is claimed is:

1. An improved apparatus for bonding semiconductor structures comprising:
equipment for treating a first surface of a first semiconductor structure and a first surface of a second semiconductor structure with formic acid;
equipment for positioning said first surface of said first semiconductor structure directly opposite and in contact with said first surface of said second semiconductor structure; and
equipment for forming a bond interface between said treated first surfaces of said first and second semiconductor structures by pressing said first and second semiconductor structures together.

2. The apparatus of claim 1, wherein said equipment for treating said surfaces of said first and second semiconductor structures with formic acid comprises a sealed tank filled partially with liquid formic acid and partially with formic acid vapor and wherein said tank comprises an inlet valve and an outlet valve and wherein opening said inlet valve connects said tank to a nitrogen gas source and allows nitrogen gas to flow through said tank and wherein opening said outlet valve allows a mixture of formic acid vapor with nitrogen gas to flow out of said tank and wherein said mixture is used for treating said surfaces of said first and second semiconductor structures.

3. The apparatus of claim 2 wherein said mixture of formic acid vapor with nitrogen gas is adjusted to comprise 4% of formic acid.

4. The apparatus of claim 3 wherein said equipment for treating said surfaces of said first and second semiconductor structures with formic acid further comprises a leak detector for detecting low levels of formic acid vapor outside of said formic acid treatment equipment.

5. The apparatus of claim 4 wherein said equipment for treating said surfaces of said first and second semiconductor structures with formic acid further comprises a nitrogen gas pressure sensor, a pressure monitor device, a nitrogen gas pressure regulator, and a nitrogen gas flow meter.

6. The apparatus of claim 5 wherein said equipment for treating said surfaces of said first and second semiconductor structures with formic acid further comprises a gas control valve configured to be materially compatible with formic acid.

7. The apparatus of claim 6 wherein said equipment for treating said surfaces of said first and second semiconductor structures with formic acid further comprises an error indicator for indicating nitrogen gas pressure below a set value.

8. The apparatus of claim 7 wherein said equipment for treating said surfaces of said first and second semiconductor structures with formic acid further comprises an electrical lock-out switch configured to shut off electrical power to said equipment in cases where an error is indicated or a formic acid leak is detected.

9. The apparatus of claim 8 wherein said tank further comprises a tank pressure gauge monitoring pressure inside said tank.

10. The apparatus of claim 9 wherein said tank further comprises high and low formic acid level sensors indicating the fill level of the liquid formic acid in said tank.

11. The apparatus of claim 10 wherein said equipment for treating said surfaces of said first and second semiconductor structures with formic acid comprises materials compatible with formic acid.

12. The apparatus of claim 11 wherein said equipment for treating said surfaces of said first and second semiconductor structures with formic acid further comprises means for preventing tipping of said equipment.

13. The apparatus of claim 12 wherein said equipment for treating said surfaces of said first and second semiconductor structures with formic acid further comprises a first enclosure cabinet configured to enclose said tank, said tank pressure gauge, said tank inlet and outlet valves, a tank bypass valve, a tank shut-off valve, and said high and low formic acid level sensors.

14. The apparatus of claim 13 wherein said equipment for treating said surfaces of said first and second semiconductor structures with formic acid further comprises at least one tubing connecting said tank to said positioning and/or bonding equipment and wherein all connections between said tubing and said tank are enclosed in said first enclosure cabinet.

15. The apparatus of claim 14 wherein said equipment for treating said surfaces of said first and second semiconductor structures with formic acid further comprises a second enclosure cabinet configured to enclose said nitrogen gas pressure sensor, said pressure monitor device, said nitrogen gas pressure regulator, said nitrogen gas flow meter, said gas control valve, said error indicator, said electrical lock-out switch, a status indicator, and a purge valve.

16. An improved method for bonding semiconductor structures comprising:
treating a first surface of a first semiconductor structure and a first surface of a second semiconductor structure with formic acid;
positioning said first surface of said first semiconductor structure directly opposite and in contact with said first surface of said second semiconductor structure;
forming a bond interface between said treated first surfaces of said first and second semiconductor structures by pressing said first and second semiconductor structures together; and
wherein said formic acid is provided by a sealed tank filled partially with liquid formic acid and partially with formic acid vapor and wherein said tank comprises an inlet valve and an outlet valve and wherein opening said inlet valve connects said tank to a nitrogen gas source and allows nitrogen gas to flow through said tank and wherein opening said outlet valve allows a mixture of formic acid vapor with nitrogen gas to flow out of said tank for treating said surfaces of said first and second semiconductor structures.
